(19) United States
(12) Patent Application Publication
(10) Pub. No.: US 2023/0036870 A1
(43) Pub. Date: Feb. 2, 2023

(54) Bending to rotation converter

(71) Applicant: Enervibe Ltd., Airport City (IL)

(72) Inventors: Dan Haronian, Efrat (IL); Michael Haronian, Efrat (IL)

(73) Assignee: Enervibe Ltd., Airport City (IL)

(21) Appl. No.: 17/779,184

(22) PCT Filed: Nov. 28, 2019
(86) PCT No.: PCT/IL2019/051302

§ 371 Date: May 24, 2022

(51) Int. Cl. A43B 3/38

(52) U.S. Cl. CPC A43B 3/38

(57) ABSTRACT

A device for converting bends of a body to electricity that includes a generator, a bending converter and a connector. The generator includes a stator and a rotor that is connected to a rotational shaft. The bending converter includes a bending arm that has a front side and a back side. The stator and the back side of the bending arm are designed to be fixed directly or indirectly to the body. The rotational shaft is connected to the connector at a first connecting point and the front side of the bending arm is connected to the connector at a second connecting point. When the body bends then the bending arm bend and rotates the rotor relative to the stator.

### TECHNICAL FIELD

The present disclosure relates to a converting bending of a mechanical structure to rotation movement and to the use of such rotation to electricity.

### BACKGROUND

The present invention describes a method for converting bending of a structure to rotation. Throughout this application the method will be referred to as the Converter. Such Converter may use the rotation for energy harvesting by coupling the rotation to a Generator, preferably Generator with gear, in order to harvest energy from structure's bending. Bending may be caused by for example by bending of human limb, bending of tire, bending of sport devices such as balls and rackets. Other applications may use such Converter in order to harvest energy from movements generate by automobile or airplane in order to support self-powered devices such as sensors. Another example is to use such Converter for converting animal limbs bending to electricity in order to support devices for tracking or health monitoring of livestock. Another example is to use such Converter for converting movement of a wing, mast or tree for harvesting power from wind and from water such as sea waves. Yet, another example is to use such Converter for converting the bending of an automobile tire for generating electricity to support tire pressure monitoring.

In this patent application we focus on energy harvesters in a shoe, but it is understood that the Converter may be used for other applications as exemplified above.

Unlike the energy harvester described in this patent application, prior art that aims to convert human walking and running to electricity, focus on the lifting of the leg up and the pressing the shoe, mainly the heel, to the ground.

KR 101911647 B1 Disclosed is an energy harvesting shoe using air pressure, as shown in FIG. 1a and FIG. 1b. The energy harvester in the shoe comprises: a sole formed with an internal space; a space separating plate dividing the internal space into a first layer and a second layer and including at least one through hole; an elastic membrane coupled to the through hole, and moved toward the first layer and the second layer in accordance with a change in the air pressure in the first layer; an energy harvester installed in the second layer to generate electricity by receiving pressure corresponding to the movement of the elastic membrane; and an air outlet for discharging the air inside the second layer to the outside of the sole or introducing air outside of the sole into the second layer.

KR 20150048019 discloses a shoe employing a piezoelectric sensor, which are capable of being self-operated based on piezoelectric energy harvesting using a piezoelectric sensors and utilized in healthcare for the wearer. This is shown schematically in FIG. 1c. An aspect of the present invention provides the multifunctional shoes comprising: a piezoelectric sensor which generates electric signals by the pressure the wearer is applying; an energy-harvesting circuit which converts the alternative current (AC) electric signals generated from the piezoelectric sensor to direct current (DC) power; and a microprocessor which receives the DC power from the energy harvesting circuit and processes the electric signals generated from the piezoelectric sensor.

CN 104489996 is another energy harvester imbedded in a shoe that is based on the piezoelectric effect as shown in FIG. 1d. The piezoelectric energy harvesting device comprises multiple piezoelectric units 1 and a piezoelectric thin film lamination layer 2, each piezoelectric unit 1 is composed of a piezoelectric material 3 and two convex elastic metal pieces 4, each two elastic metal pieces are bonded on two sides of the corresponding piezoelectric material 3, the piezoelectric units 1 are stacked at the heel of a sole of a sneaker body, the piezoelectric thin film lamination layer 2 is formed by bonding and stacking multiple PVDF piezoelectric thin films 6 and a metal thin sheet 7.

US 2014/0145450 A1 also uses the impact of the heel with the ground to harvest energy. As described in FIG. 1e, the heel plate moves downward, compressing the support springs, while a pulley system increases the magnitude of displacement, and spins a lever arm, causing rotation of the electric generator. The gear chain further increases this displacement, to increase the power produced by the electric generator as it rotates.

The prior art uses a complex mechanism to transfer the mechanical energy in the heel press against the ground to electricity. The press of the heel to the ground is very individual, it depends on the weight of the person and whether he is walking, running or jumping. In some cases, the interaction between the footwear and the ground may be violent and damage the energy harvester.

U.S. Pat. No. 8,716,877 B2 teaches a method for harvesting energy from ankle motion includes coupling a generator module across an ankle joint, the generator module including a generator and an elastic member. As shown in FIG. 1f, the generator is affixed to the leg shank and at least one of the generator and the elastic member is continuously coupled to the foot across the ankle joint. Energy may be harvested in the elastic member while generating electricity with the generator from motion of the ankle joint. Alternatively, or in addition, electricity may be generated with the generator from energy harvested in the elastic member after the energy is harvested. This method is comprised of many parts and is external to the shoe which is not practical.

The Converter described in this patent application converts the shoe natural bending at the fingers area into rotation. The Converter described in this patent application is simpler compared to prior art. In addition, the Converter is less sensitive to different way of human movement (i.e. walking, running, jumping.)

### SUMMARY

The present invention is related to energy harvester that is based on converting bending into rotation. Bending may be generated by bending of a body or by rotation of one part relative to the other such that bending is induced on the bending to rotation converter. The rotation induces rotation on a device that converts rotation into electricity such as a Generator. The rotation may also use a gearbox to induce large number of rotation as a result of bending.

### BRIEF DESCRIPTION OF THE FIGURES

FIG. 1a-FIG. 1f: Prior art.

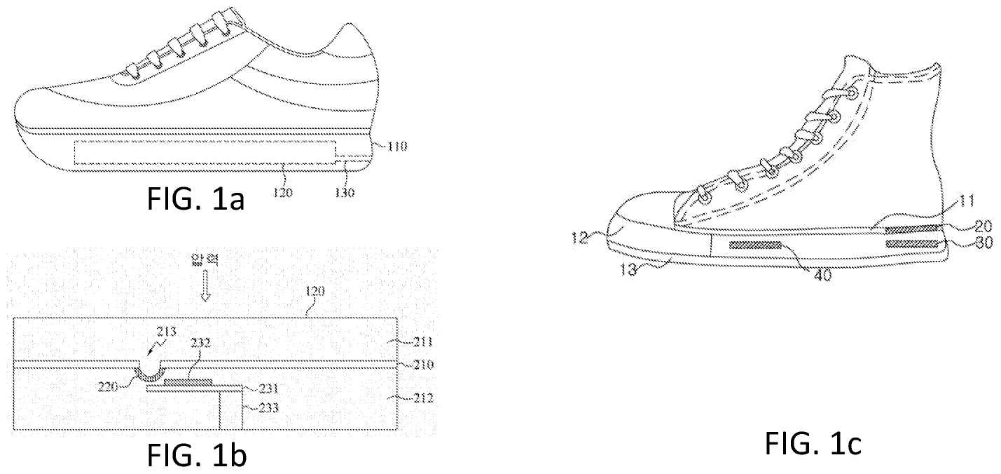

FIG. 2: Conceptual description of an Energy Harvester with two bending arms.

FIG. 3: A blow up view of the Energy Harvester with two bending arms

FIG. 4a: A side view of the Energy Harvester with two bending arm in rest position.

FIG. 4b: The Energy Harvester in FIG. 4a in bending position.

FIG. 5a: The Energy Harvester with three bending arms in rest position.

FIG. 5b: The Energy Harvester in FIG. 5a in bending position.

FIG. 6a: Another embodiment of the Energy Harvester

FIG. 6b: The Energy Harvester in FIG. 6a in bending position

FIG. 7a-7d: A description of the connection between the bending arms and the rotator.

FIG. 8a: Another embodiment of the Energy Harvester

FIG. 8b: Side view of the Energy Harvester in FIG. 8a

FIG. 9a: Another embodiment of the Energy Harvester

FIG. 9b: Side view of the Energy Harvester in FIG. 9a

FIG. 10a: Another embodiment of the Energy Harvester

FIG. 10b: Side view of the Energy Harvester in FIG. 10a

FIGS. 11a and 11b: Schematic description of the connection between bending arms and rotational shaft.

FIG. 12: General description of a generator with a gear

FIG. 13: An example of using the Energy Harvester for harvesting energy from walking.

FIG. 14: An example of using the Energy Harvester for harvesting energy from limbs capable of bending.

FIG. 15: An example of using the Energy Harvester for harvesting energy from wind or sea waves.

FIG. 16: An example of using the Energy Harvester for harvesting energy from tree.

FIG. 17: An example of using the Energy Harvester for harvesting energy from tire.

### DETAILED DESCRIPTION

This patent application is related to harvesting energy from bodies that bend back and forth by converting the bending into line movement that rotates a generator, preferable through a gear that increases the RPM of the generator.

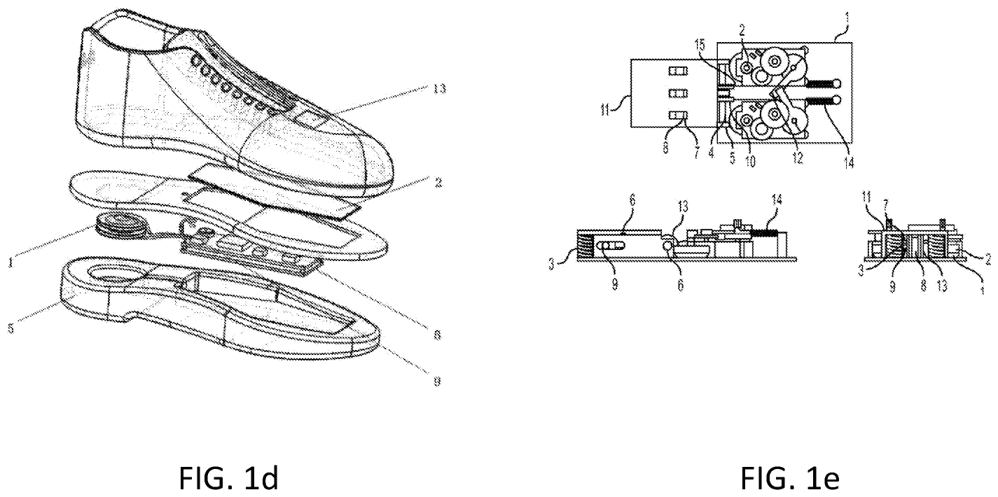

Reference is made to FIG. 2 that describes conceptually the Energy Harvester (5) that converts bends of a body (500) to electricity. The energy harvester comprises a generator (40), a bending element (9) and a converter (32). The generator (40) includes a stator (41) and a rotor (43) that is connected to a rotational shaft, and the bending element (9) includes a bending arm (30) that has a front side (301) and a back side (302). The stator and the back side of the bending arm are fixed directly or indirectly to the body (500). The rotational shaft (42) is connected to the bending to rotation converter (32) at a first connecting point (321) and the front side (301) of the bending arm (30) is connected to the bending to rotation converter (32) at a second connecting point (322). When the body (500) bends then the bending arm (30) bends and rotates the rotor relative to the stator.

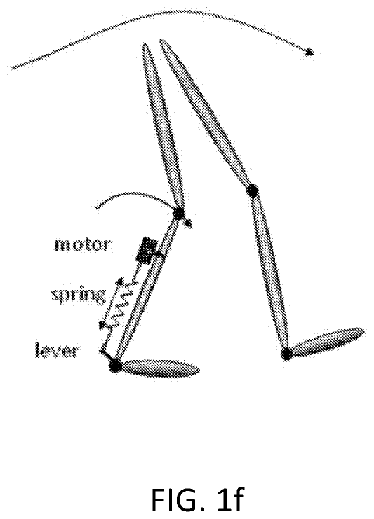

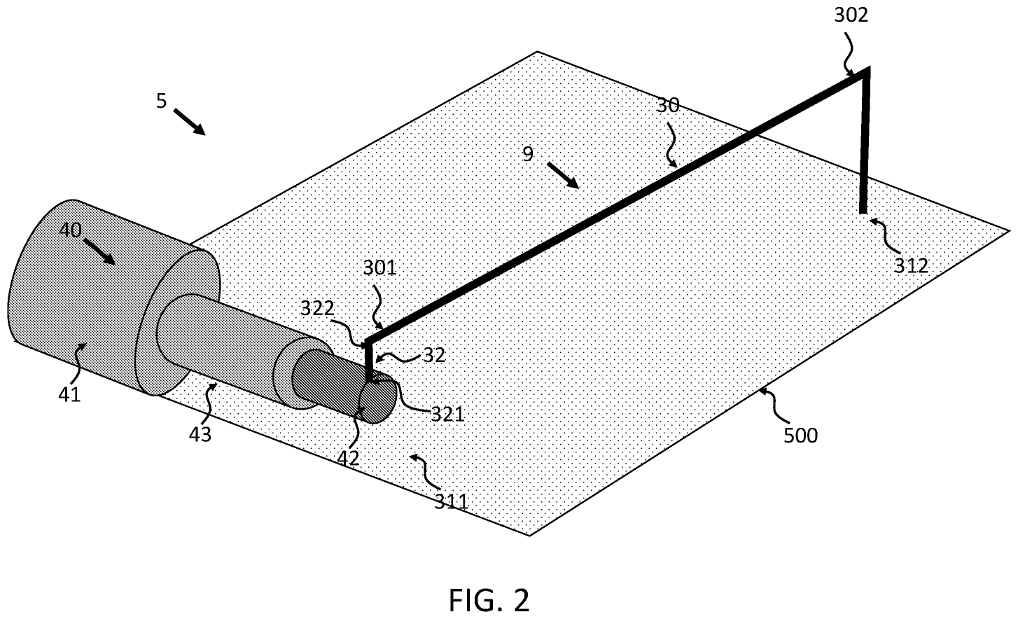

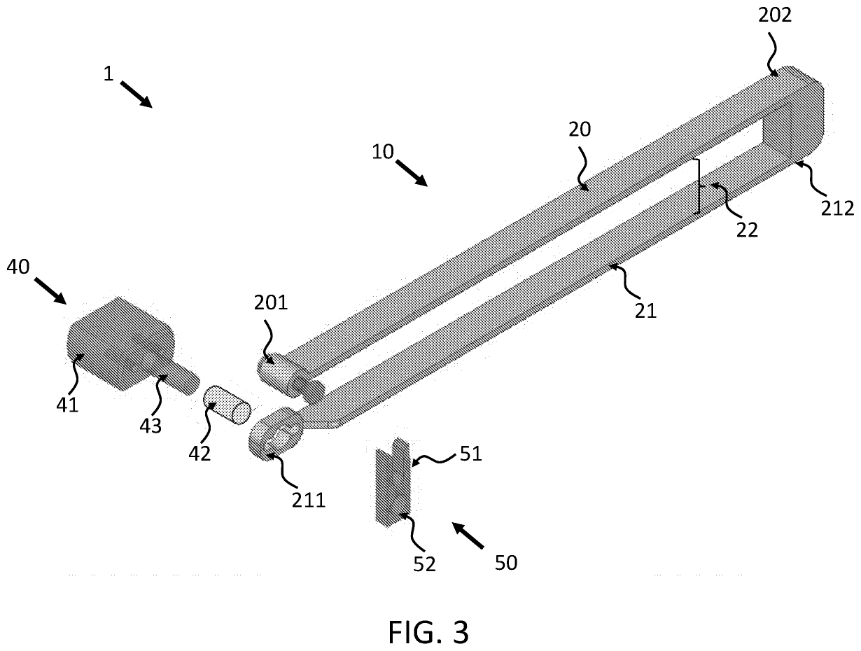

Reference is made to FIG. 3 and FIG. 4 that show another embodiment of the Energy Harvester (1) that converts the bending of a body (500) to electricity. The Energy Harvester comprises a generator (40) with a stator (41) and a rotor (43) that is connected to a rotational shaft (42), a bending converter (10), and a connector (50). The bending converter includes a first bending (20) arm that has a front side (201) and a back side (202), and a second bending arm (21) that has a front side (211) and a back side (212). The back sides (202), (212) of the bending arms, are connected one to the other in a way that forms a gap (22) between said bending arms. The rotational shaft (42) is connected to the connector (50) at a first connecting point (52) and the front side (201) of the first bending arm is connected to the connector at a second connecting point (51). The front side (211) of the second bending arm (21) is connected directly or indirectly to the connector (50) or to the stator (41). When the body bends the bending arms bend and rotate the rotor relative to the stator. FIG. 4a a side view of the embodiment shown in FIG. 3. FIG. 4b shows the Energy Harvester in bend position as induced by bending of body (500).

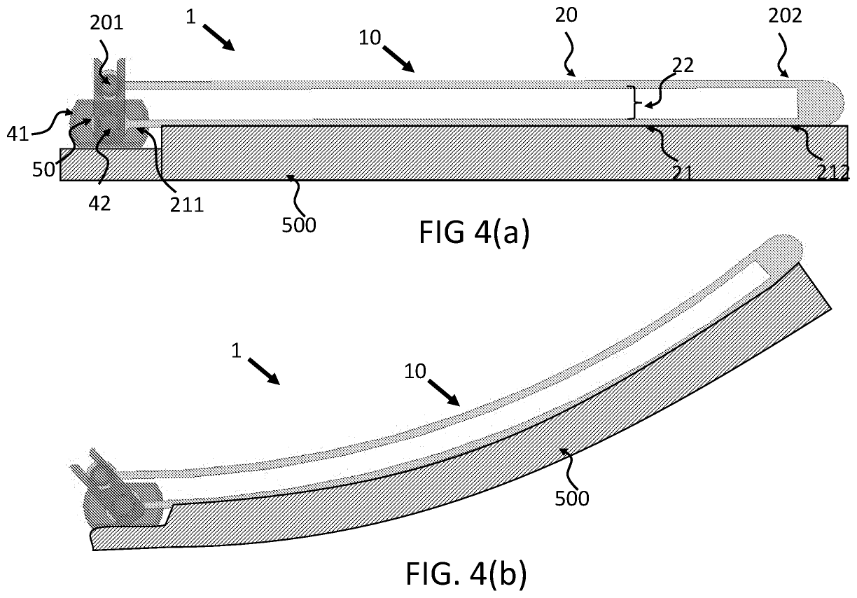

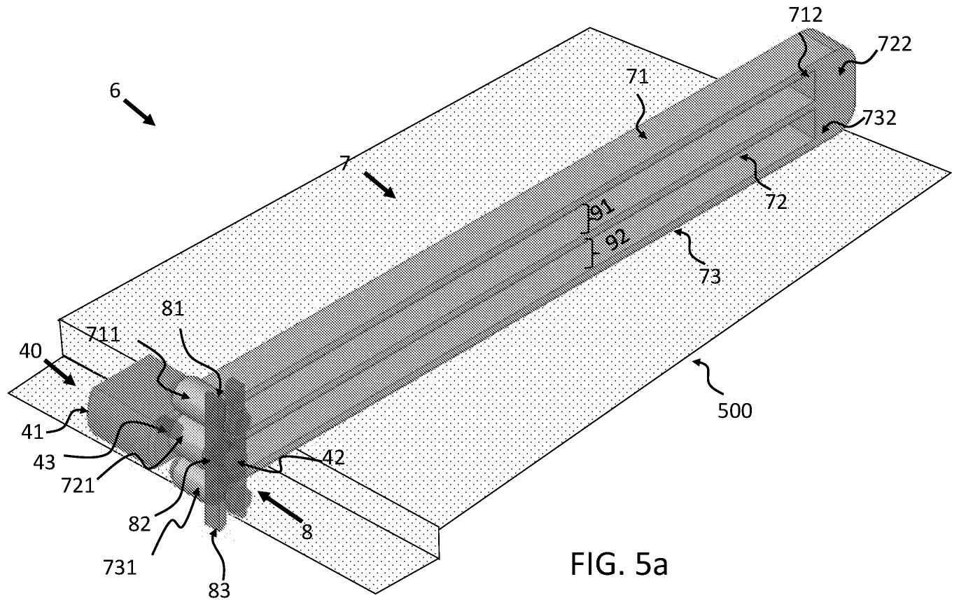

Reference is made to FIG. 5 that shows another embodiment of the Energy Harvester. The energy harvester (6) for converting bending of body (500) to electricity, comprise a generator (40) with a stator (41) and a rotor (43), a bending converter (7), and a connector (8). The bending converter (7) includes an upper bending arm (71) that has a front side (711) and a back side (712), a middle bending arm (72) that has a front side (721) and a back side (722), and a bottom bending arm (73) that has a front side (731) and a back side (732). The back sides (712) (722) (732) of said bending arms (71) (72) (73) are connected one to the others in a way that form a first gap (91) between said upper and middle bending arms (71) (72) and a second gap (92) between said middle and bottom bending arms (72) (73) that may be different from each other. The middle part (82) of the connector (8) is connected to rotational shaft (42) that is connected to the rotor (43), the upper part (81) of said connector (8) is axially connected to the front side (711) of the upper bending arm (71), and the bottom part (83) of the connector (8) is axially connected to the front side (731) of the bottom bending arm (73). The front side (721) of the middle arm (72) is connected to the stator (41) directly or through another body. The rotor rotates relative to the stator when said bending arms bend as shown in FIG. 5b.

The advantage of the embodiment shown in FIG. 5 over the embodiment shown in FIG. 3 and FIG. 4, is the fact that the bending force is divided into two arms and the force on the Generator's rotor does not include bending that may damage it.

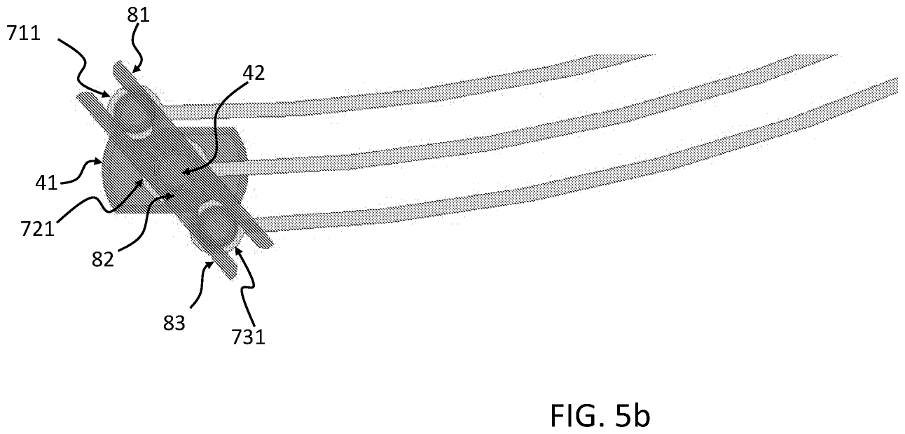

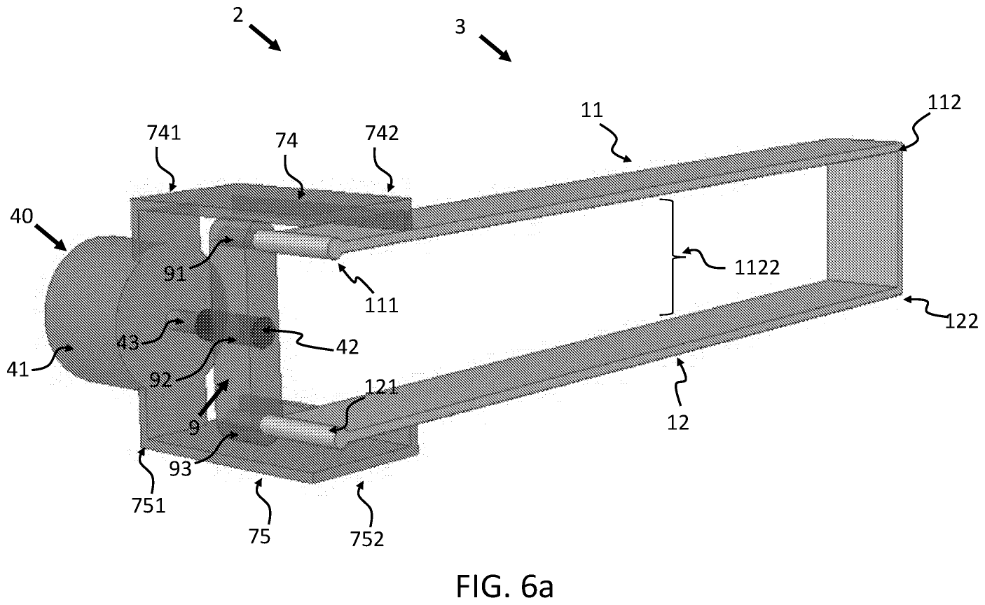

Reference is made to FIG. 6a that shows another embodiment of the Energy Harvester. The energy harvester (2) for converting movement to electricity, comprise a generator (40) that includes a stator (41), a rotor (43) that is connected to a rotational shaft (42), and an upper horizontal blocking arm (74), a bending converter (3) that includes an upper bending arm (11) that has a front side (111) and a back side (112), and a bottom bending arm (12) that has a front side (121) and a back side (122). The back sides of the upper and bottom bending arms (112), (122) are connected one to the other in a way that forms a gap (1122) between said bending arms. The Energy Harvester also comprise a connector (9). The rotational shaft (42) is connected to the connector (9) at a middle connecting point (92) and the front side (111) of the upper bending arm (11) is connected to the connector at an upper connecting point (91). The front side (121) of the bottom bending arm (12) is connected to the connector at a bottom connecting point (93). When the back sides (112) (122) of the bending arms move up relative to the stator (40) then the upper bending arm (11) is blocked by the upper horizontal blocking arm (74) and the bending arms bend and rotate the rotor relative to the stator in one direction. The Energy Harvester in FIG. 6 may further include a bottom horizontal blocking arm (75) such that when the back sides (112) (122) of said bending arms moved down relative to said stator (40), the bottom bending arm (12) is blocked by the bottom horizontal blocking arm (75) and the bending arms bend and rotate the rotor relative to the stator in the opposite direction. FIG. 6b shows the Energy Harvester described in FIG. 6a when force applied at the end side of the bending converter (i.e. at (112) or (122)), results in bending of the bending arms such that rotation is induced on the rotor. The force may be applied anywhere along the bending beam up to the contact point between beam (11) and the upper horizontal blocking arm (74).

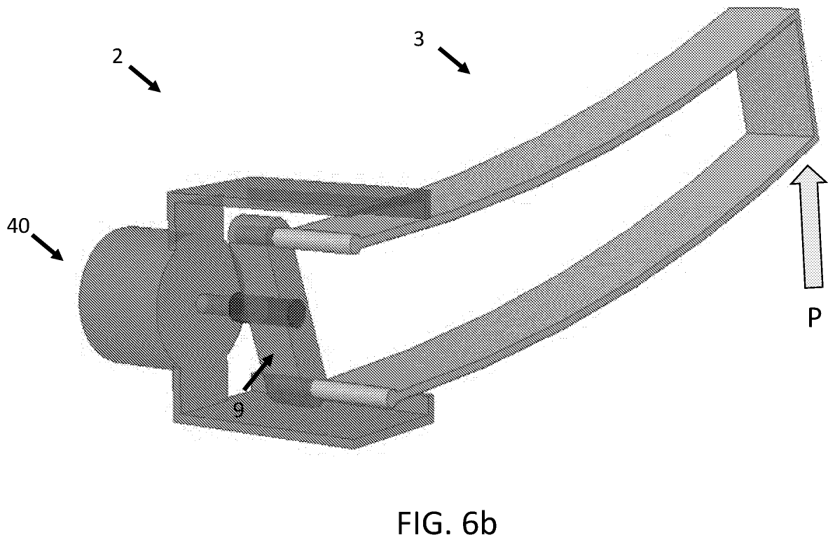

Reference is made to FIG. 7a and FIG. 7b, which exemplifies different connection point of the front side (201), of bending arm (20) to connector (50), at rest position. In FIG. 7a the radius that connects the center of (201), to the Generator's rotor (43), is at 90° relative to the X axis. A bending of the bending arms that results with travel distance of x₀, rotates rotor (43), by 45° relative to stator (41). In FIG. 7b the radius that connects the center of (201) to the Generator's rotor (43), is at 110° relative to the X axis. A bending of the bending arms that results with travel distance of x₀, rotates rotor (43), by 50°. The configuration in FIG. 7b therefore generates much higher power for the same traveling distance compared to configuration shown in FIG. 7a. The connection point also allows to tailor the design for specific applications. For example, in cases where the structure is bent at rest position. In such case, the efficiency of the conversion depends on proper location of the connecting point.

The rotation of rotor (43) gained by shifting the connection point from 90° relative to the X axis, as discussed above, may generate a bending force on the rotor which may be harmful to the Generator. Yet with two or three arms configuration, as exemplified in FIG. 7d, this bending force is canceled.

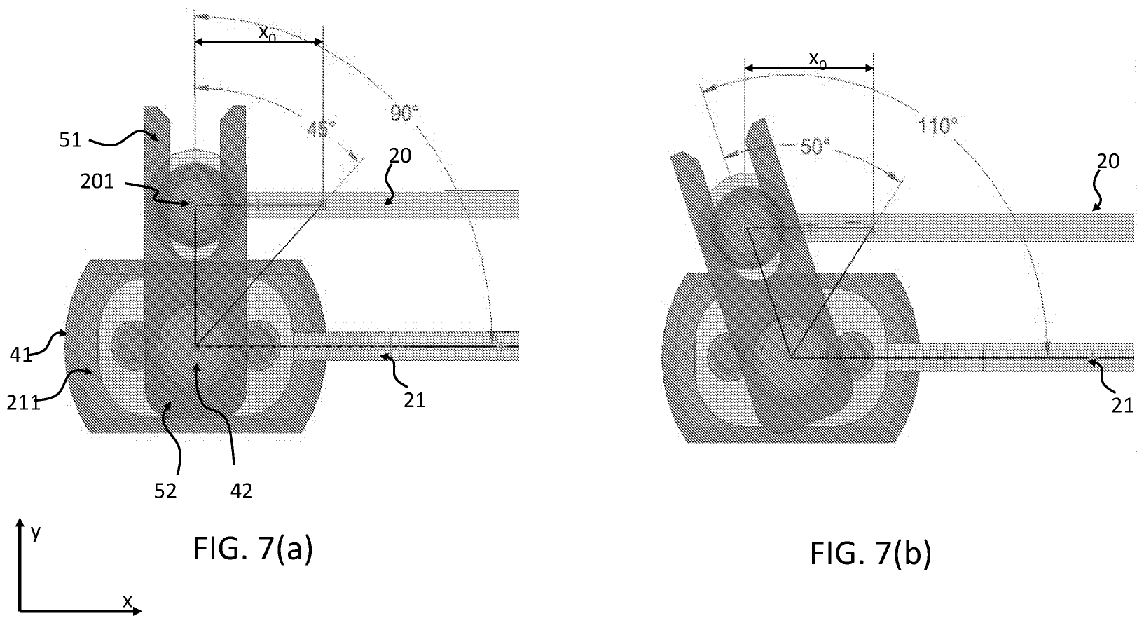

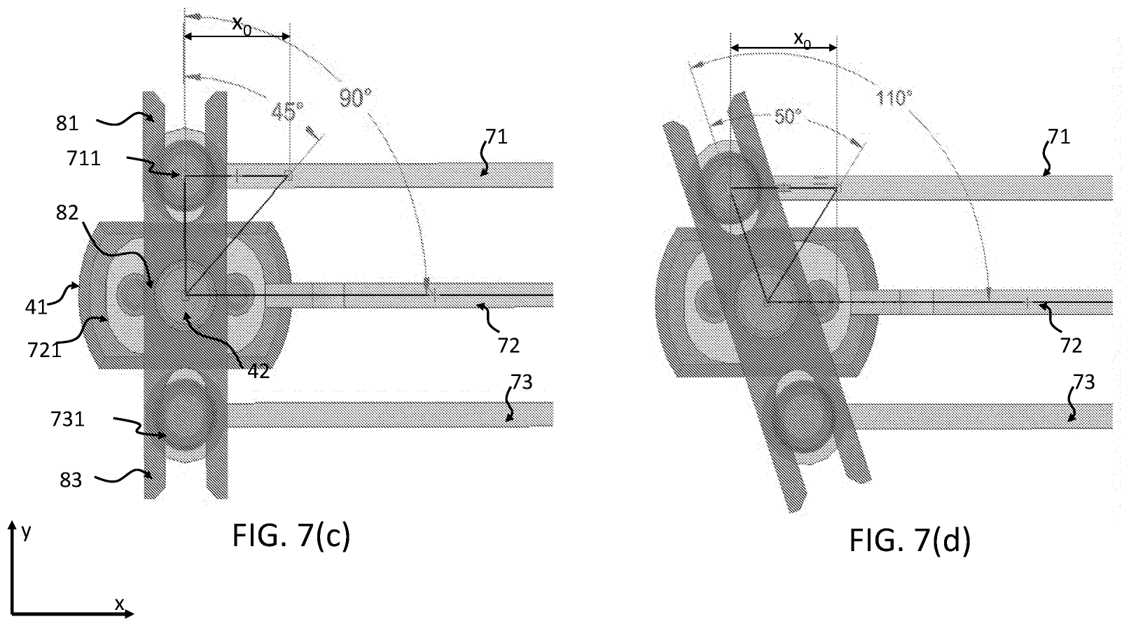

Reference is made to FIG. 8A and FIG. 8B, showing another embodiment of this patent application. The Energy harvester (100) converts bends of a body (500) to electricity. The Energy Harvester comprises a generator (40), a bending element (101) that comprises a first bending arm (102) and a second bending arm (103). The bending arms are connected to each other on the far side (1022), (1032) such that a gap (104) is formed between the two arms. The generator (40) includes a stator (41) that is fixed to the body (500) and a rotor (43) that is connected to a rotational shaft (46) that includes a gear. The Energy harvester also comprise a converter (105) that converts bending to rotation that comprises a flexible belt with teeth. The bending arms are fixed to the body such that they bend when the body bend such that their bending rotates the rotational shaft (46), that rotates the rotor relative to the stator. The converter and the rotational shaft may use friction instead of gear to convert the bending into rotation.

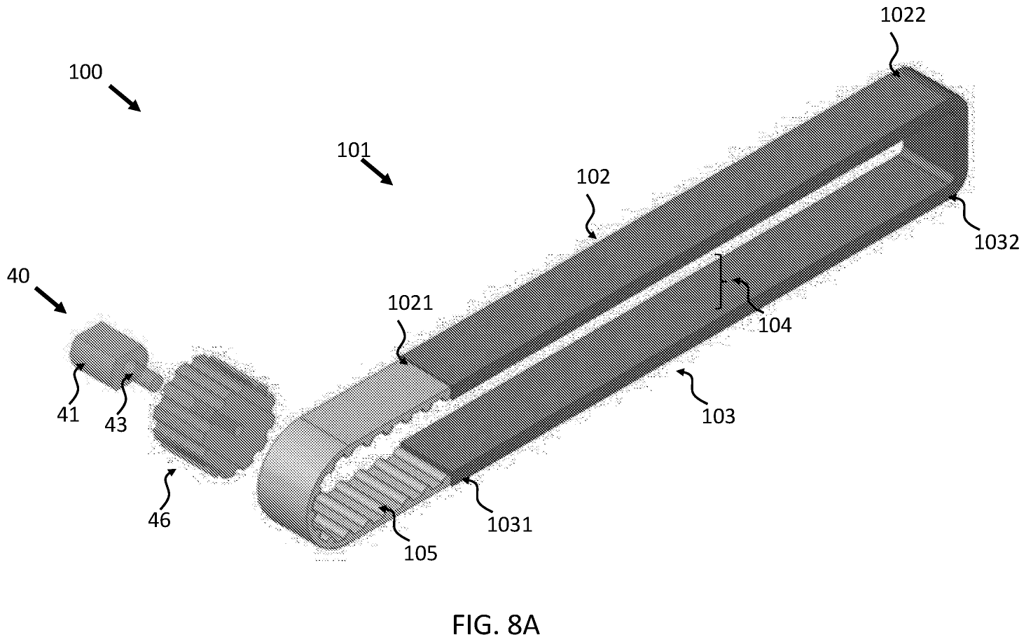

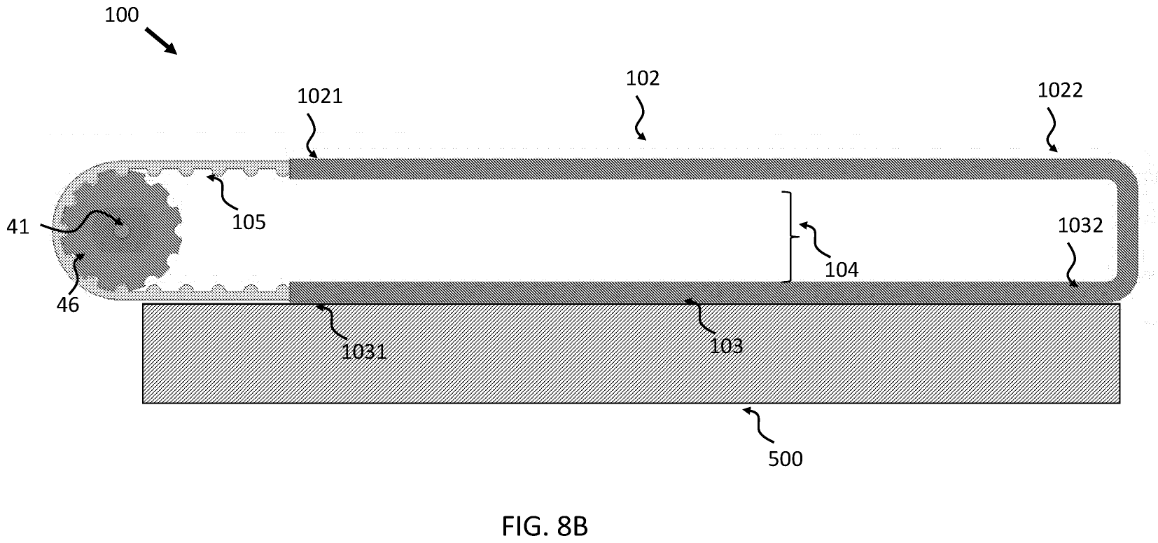

Reference is made to FIG. 9A and FIG. 9B, showing another embodiment of this patent application. The Energy harvester (600) converts bends of a body (500) to electricity. The Energy Harvester comprises a generator (40), a bending element (501) that comprises a first bending arm (502) and a second bending arm (503). The bending arms are connected to each other on the far side (5022), (5032) such that a gap (504) is formed between the two arms. The generator (40) includes a stator (41) that is fixed to the body (500) and a rotor (43) that is connected to a rotational shaft (46) that includes a gear. The Energy harvester also comprise a converter (505) that converts bending to rotation that comprises upper gear rack (505a) and a lower gear rack (505b). The bending arms are fixed to the body such that they bend when the body bend such that their bending rotates the rotational shaft (46), that rotates the rotor relative to the stator.

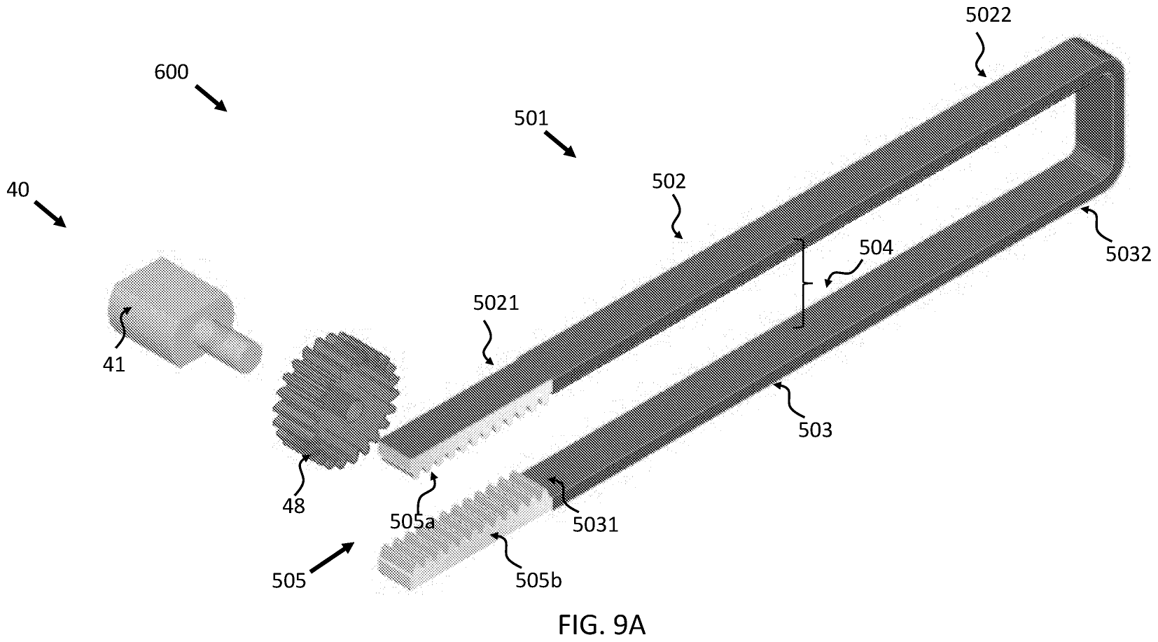

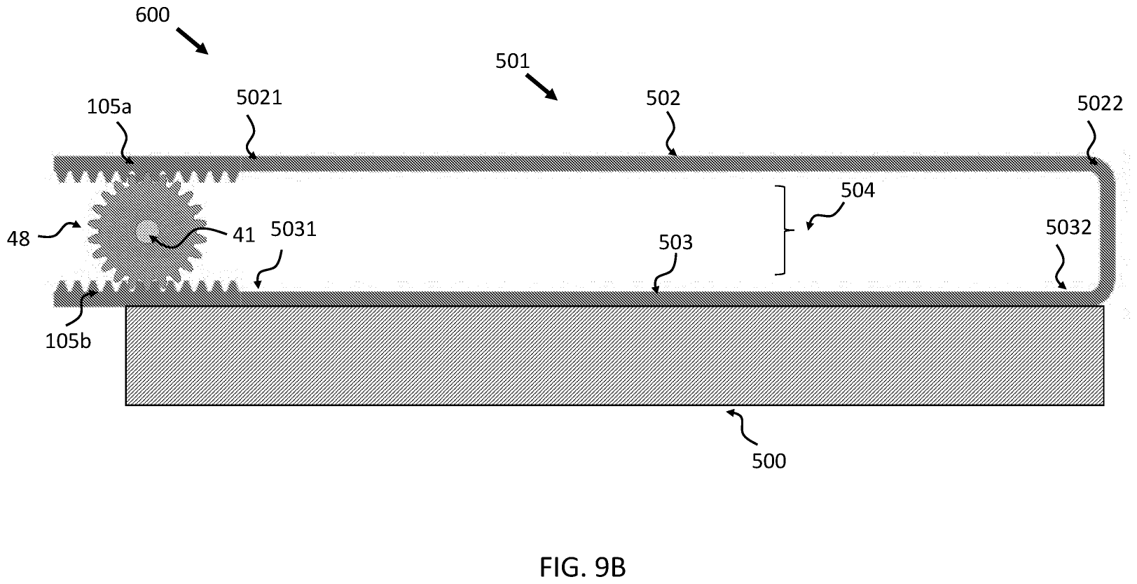

Reference is made to FIG. 10A and FIG. 10B, showing another embodiment of this patent application. The Energy harvester (400) converts bends of a body (500) to electricity. The Energy Harvester comprises a generator (40), a bending element (401) that comprises a first bending arm (402) and a second bending arm (403). The bending arms are connected to each other on the far side (4022), (4032) such that a gap (404) is formed between the two arms. The generator (40) includes a stator (41) that is fixed to the body (500) and a rotor (43) that is connected to a rotational shaft (46) that with a frictional cover. The Energy harvester also comprise a converter (405) that converts bending to rotation that comprises upper frictional element (405a) and bottom frictional element (405b). The bending arms are fixed to the body (500) such that they bend when the body bend such that their bending rotates the rotational shaft (46), that rotates the rotor relative to the stator.

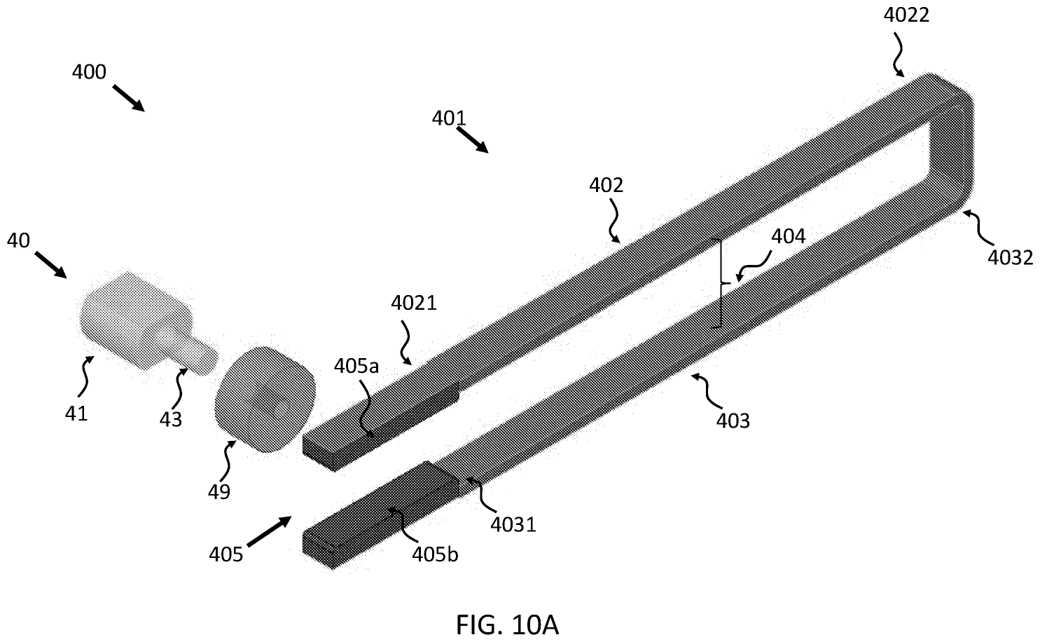

Reference is made to FIG. 11(a) and FIG. 11(b). FIG. 11(a) shows schematics view of the connection between the arms (1001-1) and (1001-2) and the rotational shaft (42). Points (1001-7) and (1001-8) are flexible or hinged such that displacement of X₀ rotates the rotational shaft by angle of α₁. In FIG. 11(b) the flexible or hinged points are moved closer to the rotational shaft such that points (1001-3) and (1001-6) are rigid while points (1001-4) and (1001-5) are hinged or flexible. In this geometry the same displacement X₀ rotates the rotation shaft by α₂ such that α₂>α₁. The configuration shown in FIG. 11(b) will therefore generate more electrical power than the configuration shown in FIG. 11(a)

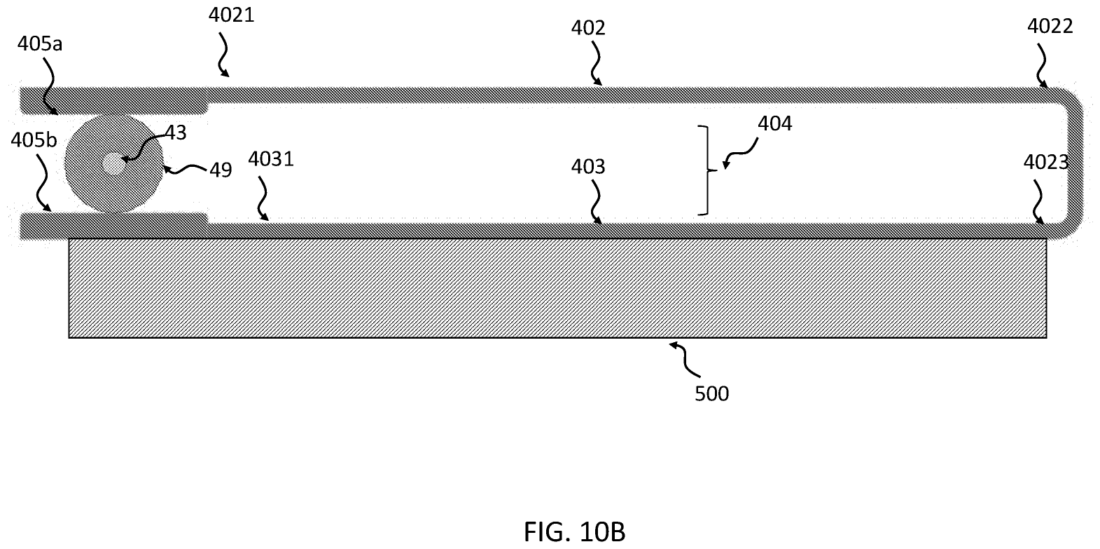

Reference is made to FIG. 12 that refers to the embodiments described in FIG. 2 through FIG. 11. The embodiment shown in FIG. 2 through FIG. 11 may further includes a gear (44) that connects the rotational shaft (42) to the rotor (43) in a way that small rotation of said rotational shaft generates multiple rotations of the rotor.

The Energy Harvesters shown in different embodiment in this patent application are designed to covert bends of a bending body (500) to electricity. Practically the stator (41) of the Generator (40) is fixed to one side of the bending body while the bending arms are allowed to bend with the body bending or movement. The term “a bending body” refers to any kind of body that bends back and forth. For example: joints of living bodies that bend and stretch back and forth, a sole of a shoe that bend back and forth while the person that wear it walks or run, any kind of element that can be tilt by wind or waves, that may include masts, trees, power poles and the like, and even a car tire where the part that is in contact with the road bends. It is noted that the bending body may include parts that are not physically or directly connected to each other, yet they form a relative movement such that induces bending of the bending arms described in this patent application. It is also noted that back and forth also includes vibration of the body that induces back and forth bending or movement of the Energy Harvester.

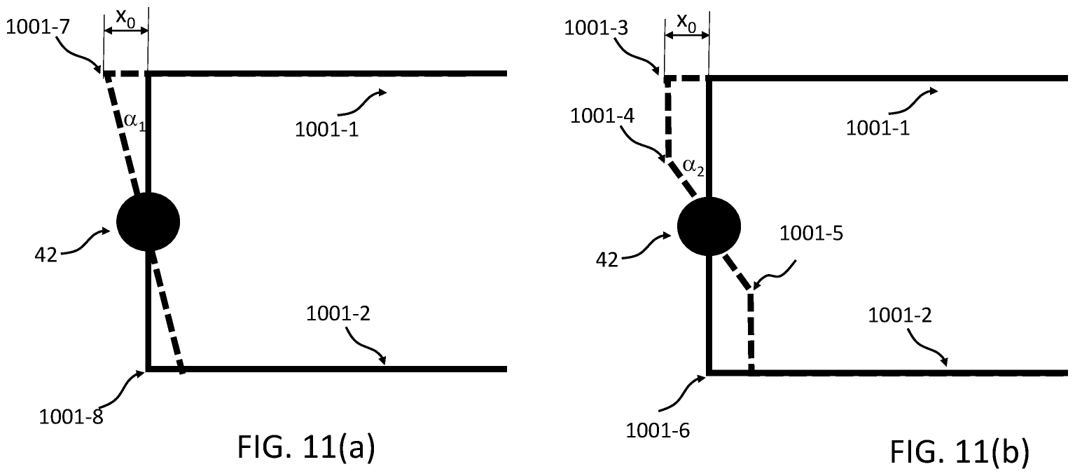

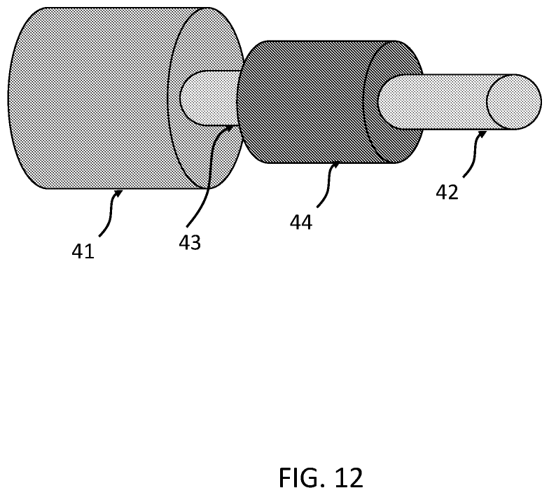

Reference is made to FIG. 13 that exemplifies the use of an energy harvester that use the Energy harvester inside a shoe (500) for converting human walking or running to electricity. The Energy harvester is location where the rotation of the Generator's rotator is optimized for human walking and running. With that respect, it is noted that the Converter main effect is in the front side of the shoe, around the Mp joint, where the fingers bend. The energy harvester can be applied to any limbs (500) that goes through bending as exemplified in FIG. 14.

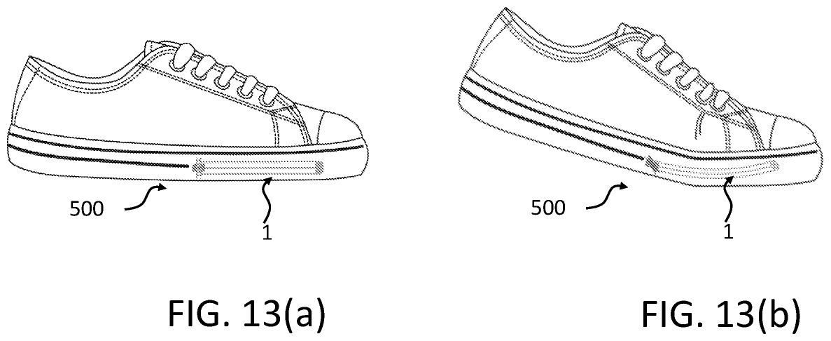

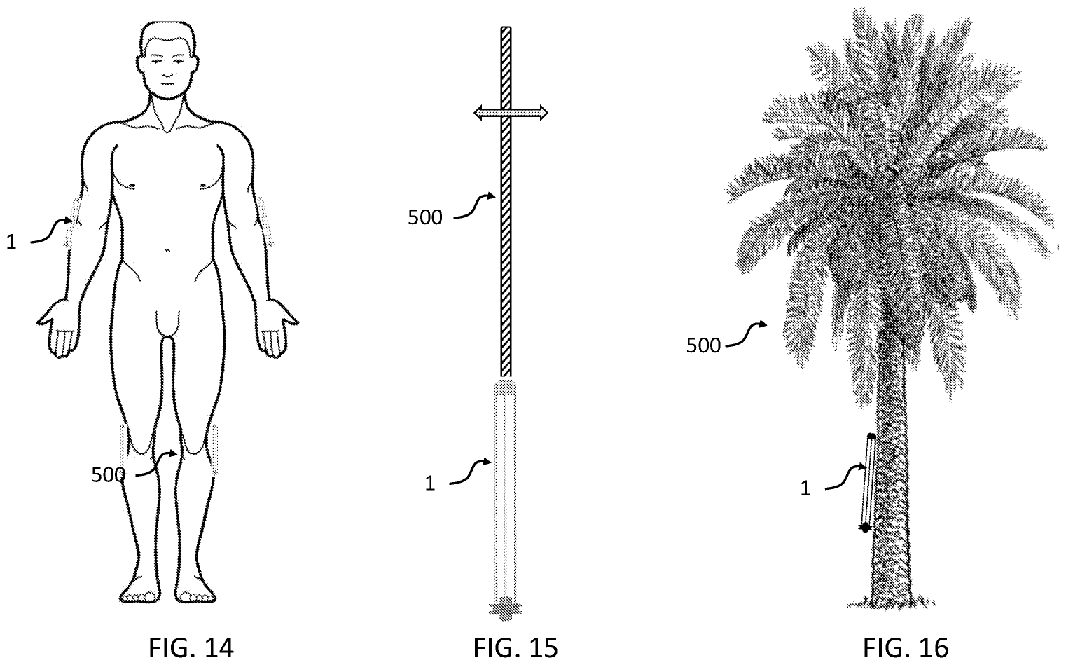

Reference is made to FIG. 15 that exemplifies the use of the energy harvester that use the Converter to convert wind power or wave power such as ocean waves. It is preferable to design the Energy Harvester such that wing (500) is designed to oscillate back and forth at a rate that is slower or equal the response time of the Generator such that full swing of the wing is used. In a similar way, FIG. 16 exemplifies the use of the Energy Harvester for harvesting energy from trees movement.

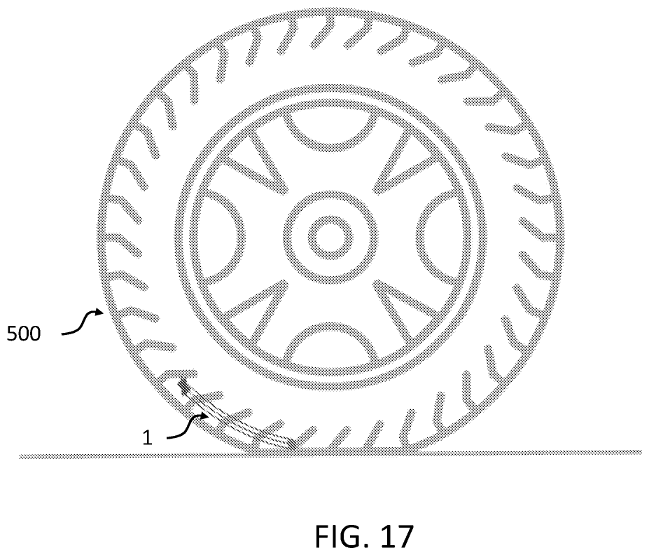

Reference is made to FIG. 17 showing the use of the Energy Harvester for harvesting energy from tire (500). The tire typically bends several millimeter at the contact with the ground. The Energy Harvester is placed on the tire such that when it reaches the contact point to the ground it bends and cause the Generator to rotate and generate electricity that is used to power sensors places inside the tire.

The Energy harvester described in embodiment of this patent application may also be used for livestock tracking and health monitoring be connecting Energy harvesters described in this patent application to livestock limbs.

The Energy harvester described in embodiment of this patent application may also be used in machines that goes through bending or small rotation. For example, bicycles, robotic arms, etc.

It is noted that by controlling the resistance of the load connected to the Generator, it is possible to adjust the mechanical load on the rotor in order to protect it from sudden impacts.

This patent application refers to a Generator as a device that converts rotation to electricity. It is noted that any device that converts rotation to electricity may be used.

It is also noted that the Energy Harvester may also include a gear that connects the rotational shaft to the rotor such that the rotation rate of the rotor, as a result of the rotation of the rotational shaft, increases. The gear refers to everything that increases the ration of the rotation of the rotor compare to the rotation of the rotational shaft. For example, the gear may be a conventional gear box. It may also comprise a sliding elements instead of actual gear.

What is claimed is:

1. A device for converting bends of a body to electricity, comprising: a generator, a bending element and a converter that converts bending to rotation;
wherein said generator includes a stator and a rotor that is connected to a rotational shaft, and wherein said bending element includes a bending arm that has a front side and a back side;
wherein said stator and said back side of said bending arm are designed to be fixed directly or indirectly to the body;
wherein the rotational shaft is connected to the bending to rotation converter at a first connecting point and the front side of the bending arm is connected to the bending to rotation converter at a second connecting point; and whereby when the body bends then the bending arm bends and rotates the rotor relative to the stator.

2. A device for converting bends of a body to electricity, comprising: a generator with a stator and a rotor that is connected to a rotational shaft, a bending element, and a converter that converts bending to rotation;
wherein said bending element includes a first bending arm that has a front side and a back side, and a second bending arm that has a front side and a back side; wherein said back sides of said bending arms are connected one to the other in a way that forms a gap between said bending arms;
wherein the rotational shaft is connected to the converter at a first connecting point; wherein the front side of the first bending arm is connected to the converter at a second connecting point; wherein the front side of the second bending arm is connected directly or indirectly to the stator; and whereby the rotor can rotates relative to the stator when said bending arms bend.

3. A device for converting bends of a body to electricity, comprising: a generator with a stator and a rotor, a bending element, and a converter that converts bending to rotation;
wherein said bending element includes an upper bending arm that has a front side and a back side, a middle bending arm that has a front side and a back side, and a bottom bending arm that has a front side and a back side; wherein said back sides of said bending arms are connected one to the others in a way that form a first gap between said upper and middle bending arms and a second gap between said middle and bottom bending arms;
wherein a middle part of said converter is connected to a rotational shaft that is connected to the rotor, an upper part of said converter is axially connected to the front side of said upper bending arm, and a bottom part of said converter is axially connected to the front side of said bottom bending arm; wherein said front side of said middle arm is connected to the stator; and whereby the rotor can rotates relative to the stator when said bending arms bend.

4. A device for converting movement of a body to electricity, comprising:
(a) a generator that includes a stator, a rotor that is connected to a rotational shaft, and an upper horizontal blocking arm;
(b) a bending element that includes an upper bending arm that has a front side and a back side, and a bottom bending arm that has a front side and a back side; wherein said back sides of said upper and bottom bending arms are connected one to the other in a way that forms a gap between said bending arms;
(c) a converter that converts bending to rotation;
wherein the rotational shaft is connected to the converter at a middle connecting point; wherein the front side of the upper bending arm is connected to the converter at an upper connecting point; wherein the front side of the bottom bending arm is connected to the converter at a bottom connecting point; and
whereby when the back sides of the bending arms moved up relative to the stator then the upper bending arm is blocked by the upper horizontal blocking arm and the bending arms bend and rotate the rotor relative to the stator.

5. The device for converting movement of a body to electricity according to claim 4 that wherein said generator further includes a bottom horizontal blocking arm; whereby when said back sides of said bending arms moved down relative to said stator then said bottom bending arm is blocked by the bottom horizontal blocking arm and the bending arms bend and rotate the rotor relative to the stator.

6. A device for converting bends of a body to electricity, comprising: a generator, a bending element and a converter that converts bending to rotation;
wherein said generator includes a stator and a rotor that is connected to a rotational shaft, and wherein said bending element includes a bending arm that has a front side and a back side;
wherein said stator and said back side of said bending arm are designed to be fixed directly or indirectly to the body;
wherein said converter converts bends of said bending arm to rotational movement of said rotational shaft, that rotates the rotor relative to the stator.

7. The device for converting bends of a body to electricity of claim 1 that further includes a gear that connects said rotational shaft to said rotor in a way that one rotation of said rotational shaft generates two or more rotations of side rotor.

8. The device for converting bends of a body to electricity of claim 2 that further includes a gear that connects said rotational shaft to said rotor in a way that one rotation of said rotational shaft generates two or more rotations of side rotor.

9. The device for converting bends of a body to electricity of claim 3 that further includes a gear that connects said rotational shaft to said rotor in a way that one rotation of said rotational shaft generates two or more rotations of side rotor.

10. The device for converting bends of a body to electricity of claim 4 that further includes a gear that connects said rotational shaft to said rotor in a way that one rotation of said rotational shaft generates two or more rotations of side rotor.

11. The device for converting bends of a body to electricity of claim 5 that further includes a gear that connects said rotational shaft to said rotor in a way that one rotation of said rotational shaft generates two or more rotations of side rotor.

12. The device for converting bends of a body to electricity of claim 6 that further includes a gear that connects said rotational shaft to said rotor in a way that one rotation of said rotational shaft generates two or more rotations of side rotor.
